(19) United States
(12) Patent Application Publication
(10) Pub. No.: US 2010/0201054 A1
(43) Pub. Date: Aug. 12, 2010

(54) TEMPORARY PROTECTION DEVICE WITH A PIVOTING LOCK

(75) Inventor: Stephane Perche, Saint Bardoux (FR)

Correspondence Address: CANTOR COLBURN, LLP, 20 Church Street, 22nd Floor, Hartford, CT, 06103, US

(73) Assignee: EXSTO, Romans Sur Isere (FR)

(21) Appl. No.: 12/666,693

(22) PCT Filed: Jun. 27, 2008
(86) PCT No.: PCT/FR2008/000915

§ 371 Date: Mar. 16, 2010

(30) Foreign Application Priority Data
Jun. 28, 2007 (FR) 0704659

(51) Int. Cl. B25B 11/00

(52) U.S. Cl. 269/37

(57) ABSTRACT

The present invention relates to a lock (3) for a device (1) for temporarily spacing an opening element with respect to a fixed element of a motor vehicle body, said lock comprising, on the one hand, locking means (21, 23) designed so that they can deform elastically under the action of the stresses exerted by the opening element and, on the other hand, a substantially cylindrical pedestal (14) provided with fastening means (16, 17, 27) which can be activated by pivoting the pedestal about its axis. The present invention also relates to a base (2) intended to cooperate with a lock according to the invention.

### TECHNICAL FIELD

The present invention relates to a temporary spacing device for an opening element on a fixed element of a motor vehicle body.

### BACKGROUND

Before the final fastening of an opening element, such as a door, hood, or tailgate, inter alia, to a fixed element of a motor vehicle body, steps of applying one or more coatings, such as protective coatings or a layer of paint, are generally carried out. During such treatments, these opening elements are not yet equipped with final closure devices, for example locks.

For this reason, temporary spacing devices are provided for keeping an opening element in a pseudo-closed position with respect to the fixed element to which it is intended to be fastened.

Document FR 2 889 227 describes a temporary spacing device comprising firstly a mounting plate for anchoring the device in the fixed element and secondly a body fastened to the mounting plate and forming an abutment against which the opening element can bear. The mounting plate comprises at least two mounting members forming stems, at least one of which is mounted movably with respect to the mounting plate such that it is able to move alternately from a withdrawn position, in which the shortest distance between the mounting members is at a minimum, to a fitted position, in which the shortest distance between the mounting members is at a maximum.

Thus, such a device enables simpler and quicker mounting and removal by snap engagement without requiring the use of special additional tools.

However, such a temporary spacing device is ultimately limited to moderately loaded applications because of the tensile loads passing through the holding clip and cannot be employed with heavy vehicles such as trucks.

### BRIEF SUMMARY

The present invention aims to alleviate the abovementioned drawback and includes for this purpose a lock for a temporary spacing device for an opening element on a fixed element of a motor vehicle body, said lock comprising firstly locking means designed to be able to deform resiliently under the action of stresses exerted by the opening element, and secondly a substantially cylindrical pedestal having mounting means which can be activated by pivoting the pedestal about its axis.

According to a preferred embodiment of the invention, the mounting means comprise at least one mounting element protruding from the lateral surface of the pedestal.

Advantageously, at least one mounting element includes a longitudinal rib.

Further advantageously, at least one mounting element has a transverse rib. The thickness of the transverse rib may be variable and preferably increases in the pivoting direction for mounting purposes.

Further preferably, the mounting means comprise at least one transverse external spur, diametrically opposite the transverse rib and provided on the side opposite the introduction end of the pedestal.

The present invention also relates to a base comprising fitting means for anchoring it in a fixed element of a motor vehicle body, a housing defining an introduction section for the insertion of the pedestal of a lock according to the invention, and connecting means designed to engage with the mounting means of said lock.

Thus, in contrast to the prior art outlined above, the invention is achieved by virtue of the fact that the forces that the locking means inevitably transmit to the body via the base do not stress the mounting means themselves. Specifically, the lock is fastened to the base following a translational introduction movement of the pedestal into the housing followed by a movement mounting it by rotation in the housing, this combination enabling the transmission of forces to be uncoupled from the actual “locking” function.

This mounting is thus particularly significant because firstly it does not require the use of any tool and secondly the mechanical integrity provided by the temporary spacing device after locking is very high.

Advantageously, the connecting means comprise at least one longitudinal groove provided in the housing.

Further advantageously, the connecting means comprise a connecting barrier near the introduction section of the housing, said connecting barrier extending parallel to the axis of the housing and having a transverse opening.

Preferably, the fitting means comprise at least one anchoring barrier extending parallel to the axis of the housing, on the side opposite the introduction section of the housing.

Further preferably, the fitting means comprise at least one anchoring peg perpendicular to the anchoring barrier.

Finally, the present invention also relates to a temporary spacing device for an opening element on a fixed element of a motor vehicle body, characterized in that it comprises a lock and a base according to the invention.

A temporary spacing device of this kind is thus highly advantageous because it can be used on both light vehicles and heavy vehicles.

In addition, even though this temporary spacing device includes two separate elements, it is nonetheless easy to transport, store and manage since it can be molded and delivered to the client in a single piece, the lock and the base then being connected by breakable links that can be severed at the last moment.

### BRIEF DESCRIPTION OF THE DRAWINGS

The implementation of the invention will be more easily understood with the aid of the detailed description given below with reference to the appended drawing, in which:

FIG. 1 is a perspective view of a temporary spacing device according to the invention, before the lock is fastened to the base;

FIG. 2 is a detail view of FIG. 1 showing the positioning of the lock before the insertion of the pedestal into the base;

FIG. 3 is a schematic perspective view of a temporary spacing device according to the invention before being assembled;

FIG. 4 is a similar view to FIG. 3 when the base has been mounted in the fixed element of the motor vehicle body;

FIG. 5 is a similar view to FIG. 4 when the lock is mounted in the base;

FIG. 6 is a detail view of FIG. 5 showing the positioning of the lock in relation to the base when it has been mounted; and

FIG. 7 is a similar view to FIG. 5 when the opening element is in the pseudo-closed position.

### DETAILED DESCRIPTION

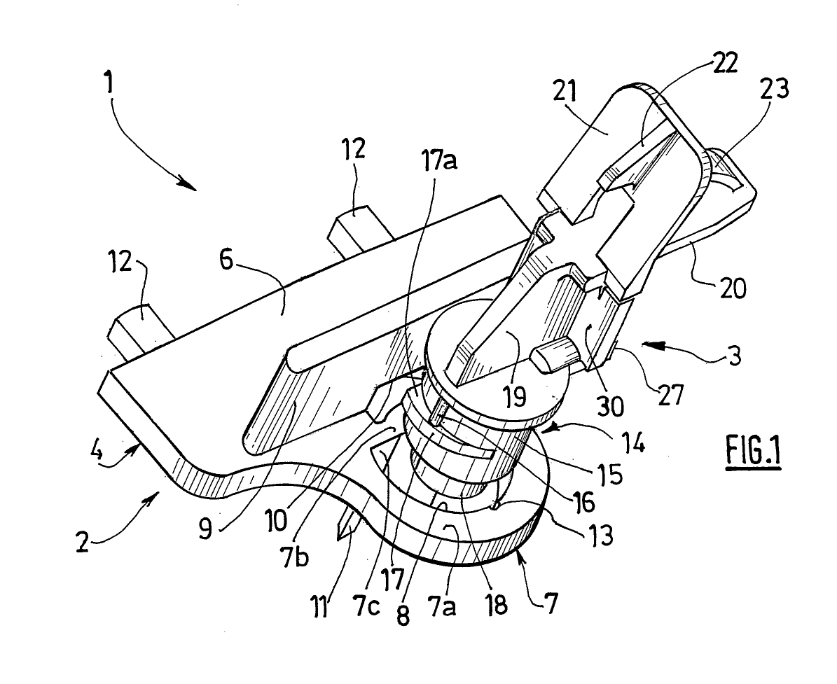

A temporary spacing device 1 according to the invention, as shown in FIGS. 1 to 7, is broken down into a one-piece base 2 and a one-piece lock 3 made of plastic, for example based on polyamide, in order that it can withstand the high temperatures to which said device is exposed during painting operations, while still having resilient properties and relatively low manufacturing costs.

More precisely, the base 2 comprises a mounting plate 4 intended to be arranged parallel to the plane in which a corresponding fixed body element 5 of a motor vehicle is contained.

This mounting plate 4 comprises a rear part 6 and a front part forming a disk-shaped housing 7 delimiting an introduction section 8.

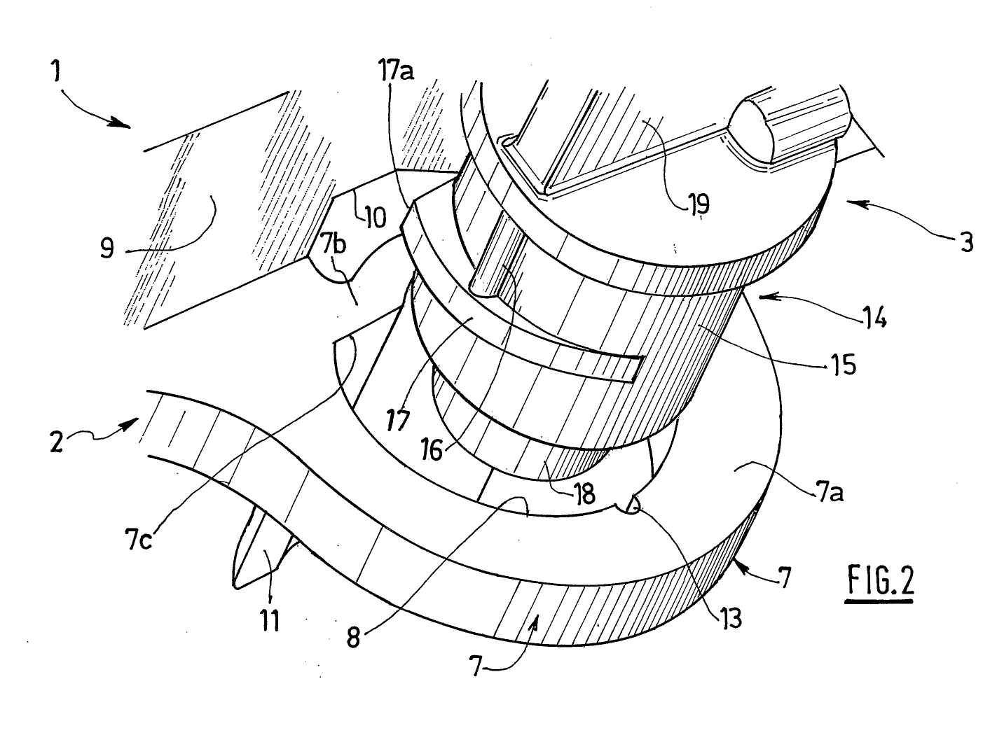

More precisely, and as shown in FIG. 2, the housing 7 comprises a rim having a perfectly circular profile 7a at the front and around part of the rear and a substantially straight profile 7b at the rear. The introduction section 8 therefore has a substantially circular geometry except at the junction of the profiles 7a and 7b where there is a corner 7c.

A connecting barrier 9, at the base of which there is a transverse opening 10, protrudes orthogonally from the mounting plate 4 near the introduction section 8, at the junction between the rear part 6 and the housing 7.

Furthermore, the mounting plate 4 is equipped with fitting means including an anchoring barrier 11 made in the form of a portion of a cylinder and two anchoring pegs 12 forming stems.

More precisely, the anchoring barrier 11 protrudes orthogonally on the side opposite the introduction section 8, behind the housing 7.

The anchoring pegs 12 are provided in the mounting plate 4 and project beyond the rear part 6. These anchoring pegs 12 are arranged parallel to the mounting plate 4 on the side opposite the introduction section 8.

As shown more particularly in FIG. 2, a longitudinal groove 13 is provided in the internal lateral surface of the profile 7a of the housing 7, facing the anchoring barrier 11.

The lock 2 comprises schematically a pedestal 14 surmounted by locking means.

More precisely, the pedestal 14 has a lateral surface 15 from which protrude firstly a longitudinal rib 16 and secondly a transverse rib 17 arranged between the longitudinal rib 16 and the introduction end 18 of said pedestal 14.

The thickness of the transverse rib 17 increases radially and said rib has a maximum external shoulder 17a designed such that the minimum distance between the axis of the pedestal 14 and said external shoulder 17a is slightly greater than the diameter of the introduction section 8.

The longitudinal rib 16 is longer than the housing 7 is thick.

The pedestal 14 has, on the side opposite its introduction end 18, a transverse external spur 27 diametrically opposite the transverse rib 17.

The pedestal 14 and the external spur 27 are surmounted by a substantially triangular wall 19 arranged parallel to the axis of the pedestal 14, and a base wall 30 perpendicular to said wall 19. A bracket 20 overhangs said wall 19 and base wall 30 and is arranged perpendicular to these walls. A tab 21 surmounts the bracket 20.

More precisely, the tab 21 has a face equipped with a protruding nose 22 occupying a part of its length and its other face is fastened to the bracket 20 by way of a bridge 23. The tab 21 is inclined such that it tilts toward the bracket 20. The tab 21 and the bridge 23 form the locking means.

Since the present invention does not relate to the locking means themselves, the person skilled in the art is directed for more details to the documents FR 2 885 633, FR 2 885 634 and FR 2 885 635, which describe how said locking means of the lock 3 are arranged. The main advantage of providing locking means able to deform resiliently is that impacts with the opening element can be absorbed. In this way, the resistance to forces is greatly improved and any deformation of the opening element or breakage of the temporary spacing device as a result of an impact is prevented.

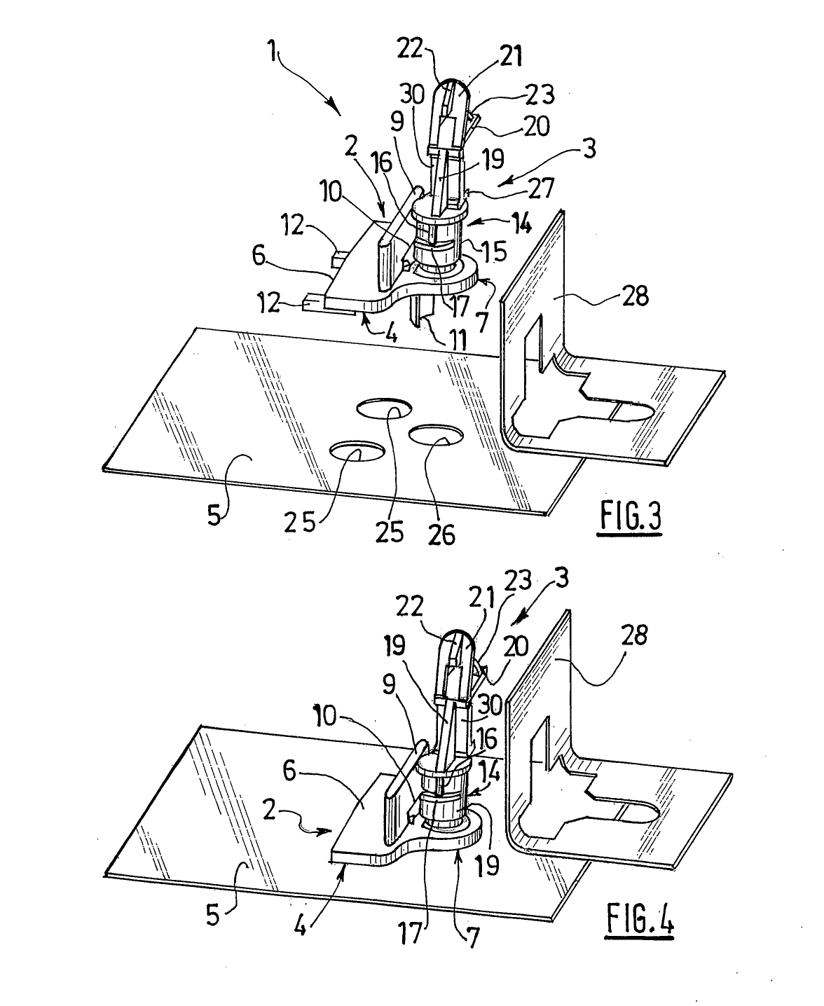

Referring to FIGS. 3 to 7, it can be seen that personnel wishing to install the device 1 will begin by positioning the base 2 in a prepared area of the fixed element 5 in which two rear bores 25 and a front bore 26 have been cut.

The personnel will firstly introduce the base 2 such that the two pegs 12 point toward the fixed element 5 and in a plane perpendicular to the latter.

The spacing between the two pegs 12 is chosen such that the distance between them is approximately equal to the distance measured between the two rear bores 25.

In the process, it is thus possible to introduce each peg 12 into the rear bore 25 which corresponds to it, and then pivot the base 2 such that the mounting plate 4 comes into contact with the element 5.

The spacing between the anchoring barrier 11 and the two pegs 12 is chosen such that the anchoring barrier 11 is automatically housed in the front bore 26 when the pegs 12 are inserted in the rear bores 25.

The base 2 is finally moved translationally rearward until the pegs 12 and the anchoring barrier 11 respectively butt against the rims of the rear bores 25 and the rim of the front bore 26. The introduction section 8 is then completely free and the pedestal 14 of the lock 3 can thus pass through it.

The lock 3 is then introduced into the base 2, as shown more specifically in FIG. 2.

For this purpose, the lock 3 is positioned such that the external shoulder 17a of the transverse rib 17 is vertically beneath the corner 7c of the housing 7. In the process, the lock 3 can be moved translationally downward so as to be fitted into the housing 7.

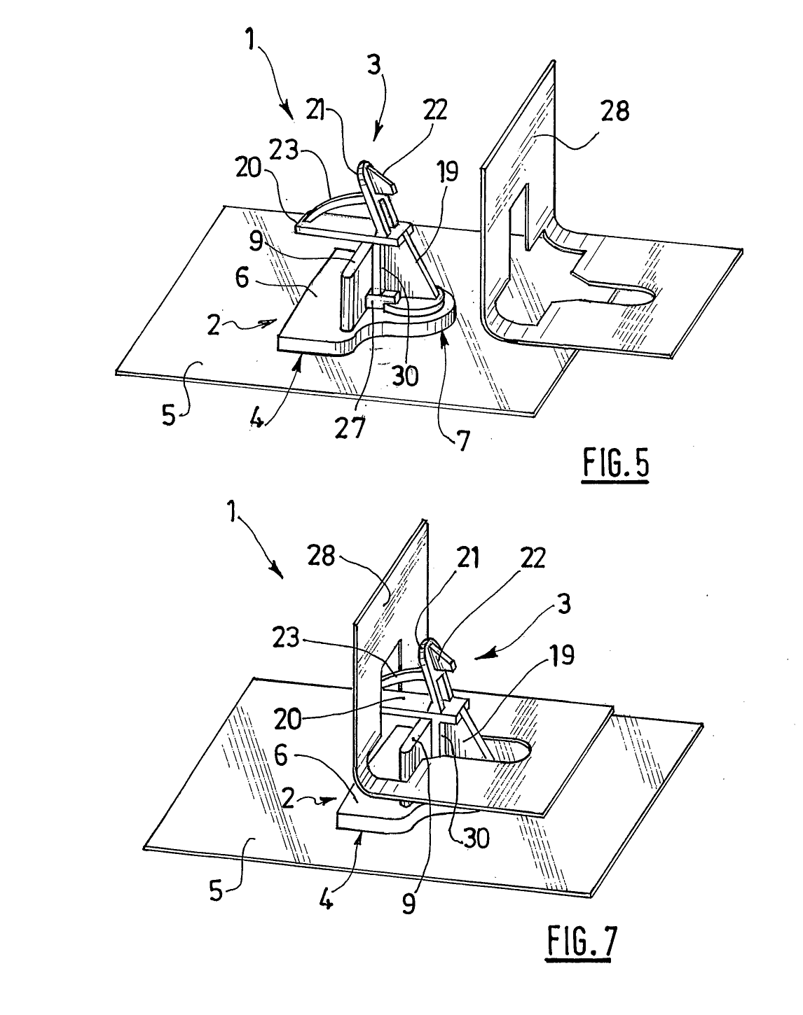

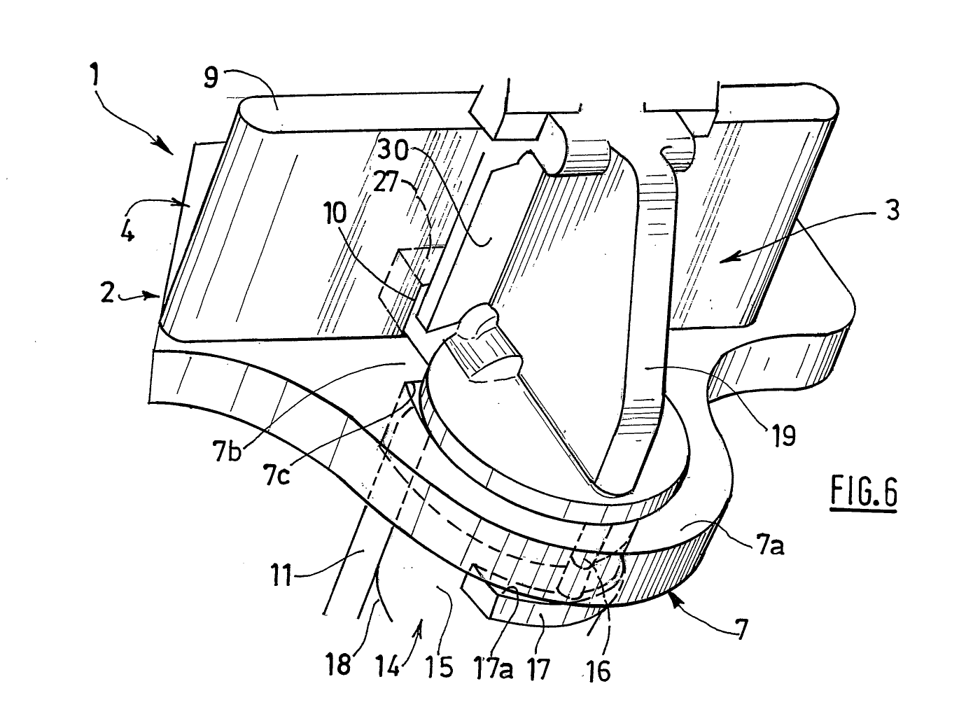

As shown in FIGS. 5 and 6, all that remains is to pivot the lock through 90° counterclockwise until the longitudinal rib 16 is housed in the corresponding longitudinal groove 13. It should be clearly understood that this pivoting is made possible by virtue of the fact that the material chosen for the lock 3 and the base 2 enables resilient deformations at the longitudinal rib 16, the latter recovering its original form when it is housed in the longitudinal rib 13.

In the process, the transverse rib 17 is located under the housing 7 and the external spur 27 is housed in the transverse opening 10 until it comes into abutment against the connecting barrier 9.

More precisely, the lock 3 is thus securely fastened in the base 2 since, apart from the fact that it is held in position by the longitudinal rib 16 fitted in the longitudinal groove 13, this lock 3 is firstly prevented from undergoing translational movement by the external spur 27 arranged in the transverse opening 10 and secondly is prevented from rocking backward and forward, partly by the base wall 30, which butts against the barrier 9, and partly by the external spur 27 arranged in the transverse opening 10.

However, it should be understood that firstly the anchoring barrier 11 can also form an abutment with regard to the pedestal 14 preventing any rocking forward of the lock 3, and secondly the transverse rib 17, depending on its position along the lateral surface 15, may come into abutment against the profile 7a of the housing 7 if said lock 3 rocks backward or moves translationally upward.

The longitudinal rib 16, the transverse rib 17 and the external spur 27 thus form the means for mounting the lock 3, while the groove 13 and the transverse opening 10 in the connecting barrier 9 form the means for connecting the base 2.

The personnel can finally close the opening element 28. The latter conventionally hits the nose 22 of the tab 21. The latter is then rotated counterclockwise and moves aside under the action of the opening element 28, offering minimal resistance. Once the opening element 28 is in its pseudo-closed position, the tab 21 and the bridge 23 are released from any stress and can thus recover their original forms, as shown in FIG. 7.

The opening element 28 is now in abutment against the barrier 9, as shown more particularly in FIG. 7.

When the paint application operations are complete, it is possible to remove the opening element 28 from the locking means by forcing the tab 21 aside. All that is then required is to pivot the lock 3 through 90° clockwise and then move it translationally upward in order to remove the lock 3 from the base 2 and finally to detach the base 2 from the fixed element 5.

It is then possible to wash the base 2 and the lock 3 and reuse them, either with light vehicles or with heavy vehicles.

Although the invention has been described in connection with particular exemplary embodiments, it is clear that it is in no way limited thereby and that it includes any technical equivalents of the means described and their combinations, as long as these are within the scope of the invention.

1. A lock for a temporary spacing device for an opening element on a fixed element of a motor vehicle body, said lock comprising:
locking means designed to be able to deform resiliently under action of stresses exerted by the opening element, and
a substantially cylindrical pedestal having mounting means which can be activated by pivoting the pedestal about its axis.

2. The lock as claimed in claim 1, wherein the mounting means comprise at least one mounting element protruding from the lateral surface of the pedestal.

3. The lock as claimed in claim 2, wherein at least one mounting element comprises a longitudinal rib.

4. The lock as claimed in claim 3, wherein at least one mounting element comprises a transverse rib.

5. The lock as claimed in claim 4, wherein a thickness of the transverse rib is variable.

6. The lock as claimed in claim 5, wherein the thickness of the transverse rib increases in a pivoting direction for mounting purposes.

7. The lock as claimed in claim 4, wherein the mounting means comprise at least one transverse external spur, diametrically opposite the transverse rib and provided on a side opposite an introduction end of the pedestal.

8. A base comprising:
fitting means for anchoring the base in a fixed element of a motor vehicle body,
a housing defining an introduction section for insertion of the pedestal of a lock as claimed in claim 1, and
connecting means designed to engage with the mounting means of said lock.

9. The base as claimed in claim 8, wherein the connecting means comprise at least one longitudinal groove provided in the housing.

10. The base as claimed in claim 8, wherein the connecting means comprise a connecting barrier near an introduction section of the housing, said connecting barrier extending parallel to an axis of the housing and having a transverse opening.

11. The base as claimed in claim 8, wherein the fitting means comprise at least one anchoring barrier extending parallel to the axis of the housing, on the side opposite the introduction section of the housing.

12. The base as claimed in claim 11, wherein the fitting means comprise at least one anchoring peg perpendicular to the anchoring barrier.

13. A temporary spacing device for an opening element on a fixed element of a motor vehicle body, comprising a lock as claimed in claim 1 and a base comprising fitting means for anchoring the base in a fixed element of a motor vehicle body, a housing defining an introduction section for insertion of the pedestal of the lock, and connecting means designed to engage with the mounting means of said lock.
